(19) United States
(12) Patent Application Publication
(10) Pub. No.: US 2004/0010887 A1
(43) Pub. Date: Jan. 22, 2004

(54) Handle cushion and method for use thereof

(76) Inventor: Michael B. Cohen, Delmar, NY (US)

Correspondence Address: Michael Cohen, 65 Oldox Rd., Delmar, NY, 12054, US

(21) Appl. No.: 10/199,838

(22) Filed: Jul. 22, 2002

(51) Int. Cl. E05B 1/00

(52) U.S. Cl. 16/431

(57) ABSTRACT

The present invention is a detachable handle cushion comprising a flexible flat structure having a cushioning element on one surface of the structure, that is configured to attach to an elongated object such as a luggage handle, a load carrying rope, or a heavy machinery handle. The handle cushion is designed to change from a flat configuration into a closed configuration by being wrapped around the handle.

### FIELD AND BACKGROUND OF THE INVENTION

The current invention relates to detachable handle pads and, more specifically, to cushioned handle pads. In everyday life there is a demand for carrying heavy loads. However, many of the handles on these loads are not comfortable, they are too narrow and are made of inferior materials. Some luggage case manufacturers have tried to address the need for travelers to comfortably carry suitcases and bags considerable distances or to lift them while transferring them between surfaces of different heights, for example, from inside of a car trunk up onto the back of a minibus. The manufacturers of luggage apparel provided fixed leather extensions to the handles. These handles are generally made of leather and they have dimensions so as to spread the load of the heavy luggage more evenly throughout a person's palm. The result is not sufficient in cushioning the palm from extreme situations of stress on the hand during lofting or lowering of the luggage. Furthermore, the handles are not expandable and not detachable. In some luggage case models the handle attachment is detachable, but it is rendered of inferior quality and is easily lost.

There is further need for handle cushions when makeshift, narrow handles, like strings or strips suspend loads. An example is plastic shopping bags that present problems to senior citizens and persons with tender hands.

There are other situations where handles must be cushioned against harmful effects of load, vibration or sudden stress. These cases include athletic equipment handles, jackhammer and other industrial equipment handles.

There is therefore a recognized need for, and it would be highly advantageous to have, a handle for carrying of heavy loads that cushions a hand and protects it from a stress and pressure. It would be of further advantage if such handle be easily attachable, simple in construction and manufacture.

### SUMMARY OF INVENTION

It is an object of the present invention to provide a cushion grip for fitting onto handles of heavy loads and heavy equipment.

The present invention is a detachable handle cushion comprising a flexible flat structure having a cushioning element disposed on at least one surface of the structure, the structure configured to attach to an elongated object, wherein the structure is designed to change from a flat configuration into a closed configuration, the closed configuration encompassing the elongated object.

According to one feature of the present invention, the first surface of the structure contains one fastener for fastening the first surface onto second surface, thereby allowing to form the closed configuration until intentionally changed into the flat configuration.

According to another feature of the invention, the cushioning element is made of a material selected from a group of materials including synthetic and natural materials.

According to another feature of the invention, the cushioning element is made of a material selected from a group of materials including foam, gel, liquid, cork, blister and bubble materials.

According to yet another feature of the invention, the at least one surface is configured to maintain frictional contact between the structure in the closed configuration and the elongated object encompassed within the structure, wherein the frictional contact is sufficient to prevent any movement of the structure relative to the elongated object.

According to yet another feature of the invention, the cushioning element is detachable from said structure.

According to another feature of the present invention, the elongated object is at least one handle.

According to another feature of the present invention, the elongated object is a machinery handle.

According to yet another feature of the present invention, the elongated object is an athletic equipment handle.

According to a further feature of the present invention, the elongated object is a belt.

According to a further feature of the invention, the elongated object is a string.

According to yet another aspect of the present invention there is provided a method for use of a handle cushion, the method comprising the steps of:

(a) providing a handle cushion having:

(i) a flexible flat structure having a cushioning element disposed on at least one surface of said structure;

(ii) the structure configured to attach to an elongated object;

wherein the structure is designed to change from a flat configuration into a closed configuration, the closed configuration encompassing the elongated object;

(b) wrapping the handle cushion around the elongated object; and

(c) grasping the cushion containing the elongated object encompassed therein.

According to another feature of the method in the invention, the wrapping further comprises attaching the cushion to the elongated object until intentionally detached.

According to yet another feature of the method in the invention, the wrapping further comprises fastening the first surface of the cushion to the second surface, thereby encompassing the elongated object within the cushion.

According to yet another feature of the method in the invention, the wrapping is accomplished by (d) pulling apart at distal edges of the cushion; (e) fitting the cushion around an elongated object; and (f) fastening said distal edge onto said surface until firmly attached.

The present invention successfully addresses the shortcomings of the existing handle cushions by providing a handle cushion that is simple, reliable, and easy to manufacture.

### BRIEF DESCRIPTION OF DRAWINGS

The invention is herein described, by way of example only, with reference to the accompanying drawings. When the drawings are referenced in detail, it is stressed that the particular features shown are by way of example only and for purposes of illustrative discussion of the preferred embodiments of the present invention only, and are presented in the case of providing what is believed to be the most useful and readily understood description of the conceptual aspects of the invention.

In the drawings:

FIG. 1 is a cross sectional view of the handle cushion in the invention detached and in the open position, wherein the SIDE A view thereof is facing downwards.

FIG. 2 is a cross sectional view illustrated in FIG. 1.

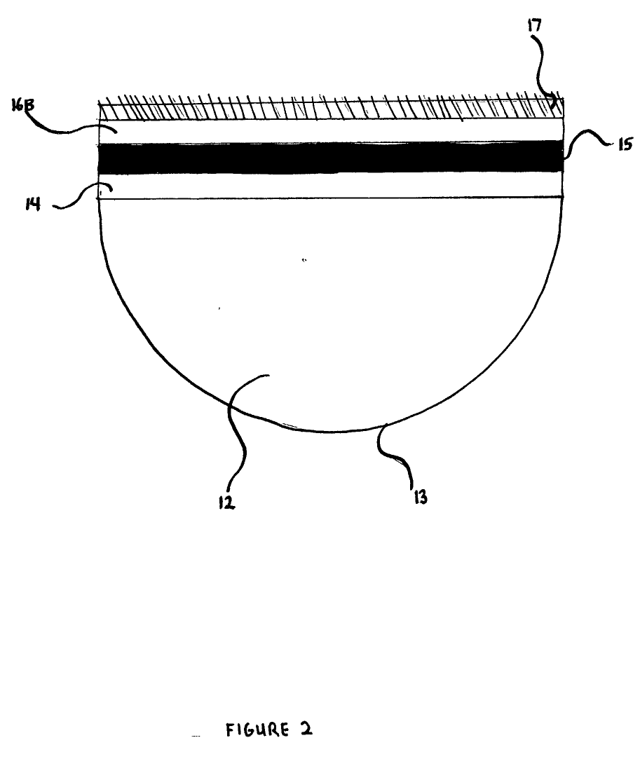

FIG. 3 is a cross sectional view of the handle cushion in the invention in the closed form.

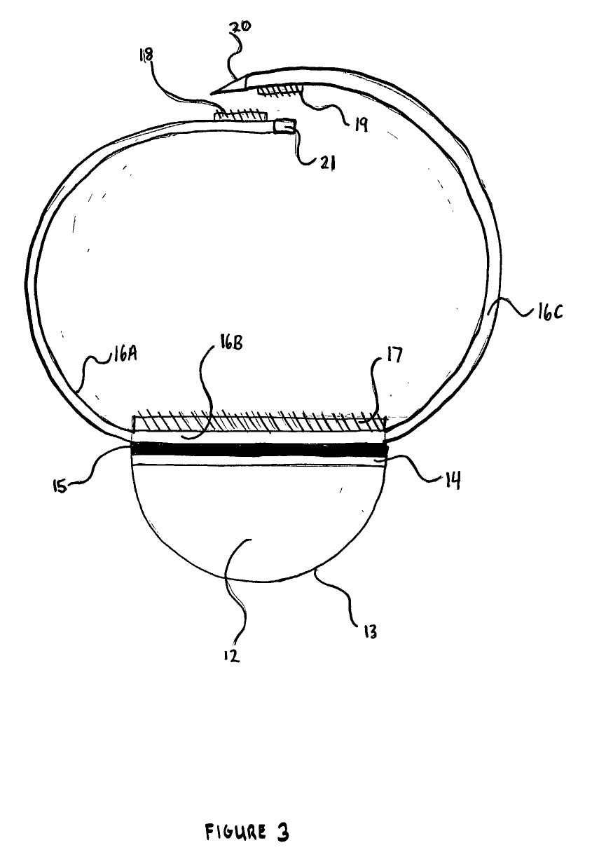

FIG. 4 is a cross sectional view illustrated in FIG. 2.

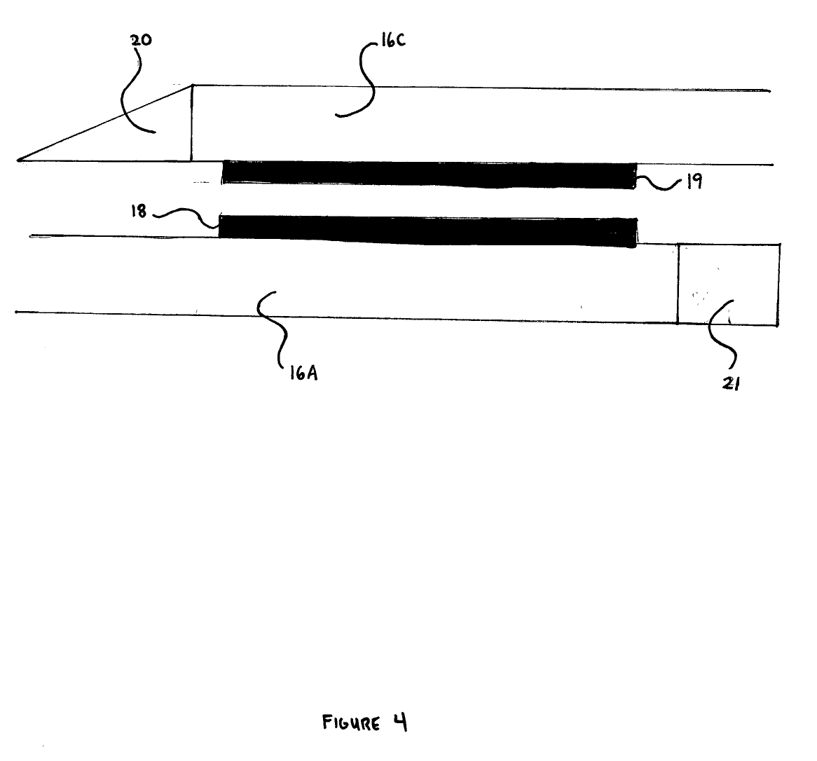

FIG. 5 is a top planar view of the invention, wherein the view of SIDE A of the invention faces downwards.

### DETAILED DESCRIPTION OF PREFERRED EMBODIMENTS

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

As used herein in the specification and in the claims section that follows, the term “elongated object” and the like refers to objects such as lengths of a material, the lengths whose ends are attached to a bulk, piece of machinery, or a solid surface. Therefore, the handle can be found on luggage, crates, boxes, large bulky objects and machinery. The elongated object is also a handle on an appliance or a makeshift handle improvised for carrying objects otherwise impossible to carry. Rope, string, wire, cable and cord is also referred to as elongated object. The term also refers to belts, straps, seat belts and sport equipment handles.

The term “fastener” refers to any device that serves to attach one object onto itself or two or more objects to each other.

The term “cushion” also refers to any device that is capable of absorbing sudden or lasting increases in stress or load on a surface being cushioned.

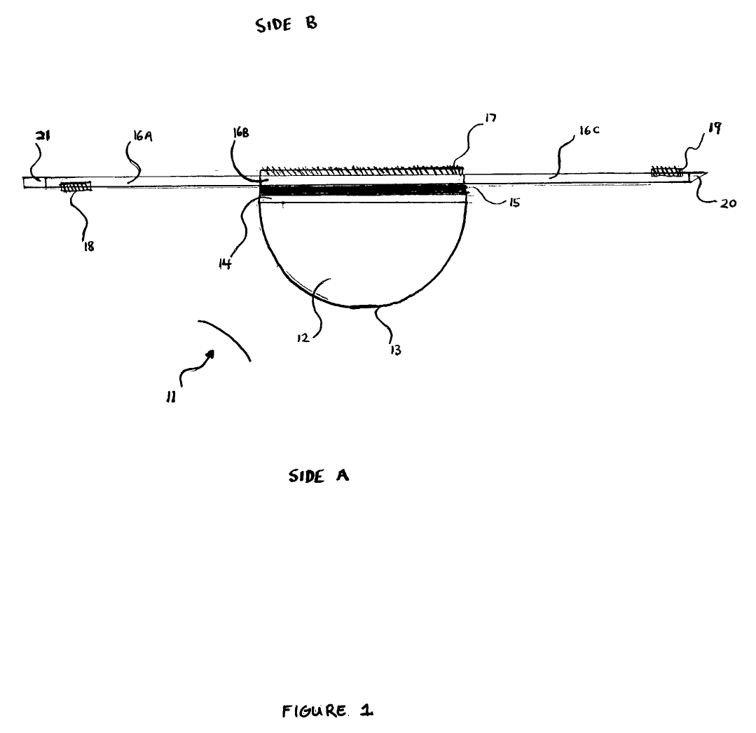

In FIG. 1, a cushion grip 11 in the present invention comprises a cushioning element 12 manufactured from gel, latex, silicone or other soft, resilient yet durable materials. Cushioning element 12 is encased and disposed within a sheath 13, that is made of materials like rubber, elastic polymers or other suitable polymers.

A flexible element 14, rectangular in cross section, is disposed internally within and provides structural reinforcement to sheath 13. Flexible element provides grip 11 with longitudinal resiliency and structural support along the longitudinal axis of grip 11. Flexible element 14 is made of plastic, metal, rubber, cardboard and other suitable materials. Flexible element 14 and a connective strip 15 are preferably of same dimensions and both extend along the longitudinal axis of cushion grip 11. Connective strip 15 serves as a connection for fastening cushion grip 11 to strap 16b.

Sheath 13 and strap 16b are fastened to connective strip 15 by any methods known in the art which can further employ fasteners of the hook-and-loop (Velcro®), zipper, snap button, stitched, woven string, and staple type of fasteners. Sheath 13 is made of rubber, fabrics, animal skins, elastic polymers, other polymers, or other suitable materials known in the art. Straps 16a, 16b, and 16c are made of polyester, fabrics, plastics, metals, rubbers, polymers or any other suitable materials known in the art.

Traction strip 17 is disposed superior on the strap 16b further providing structural reinforcement to the combination of flexible element 14, connective strip 15, and strap 16b. Traction strip 17 is manufactured from a material structurally resistant to external bending and loading stresses so as to maintain the linear form of the cushioned grip 11 in the invention. Traction strip 17 can be provided with a number of ridges that preferably made of rubber, sufficient to impart traction to cushion grip 11 as it contacts a load handle, preventing any undesired movement of cushion grip 11 relative to the load.

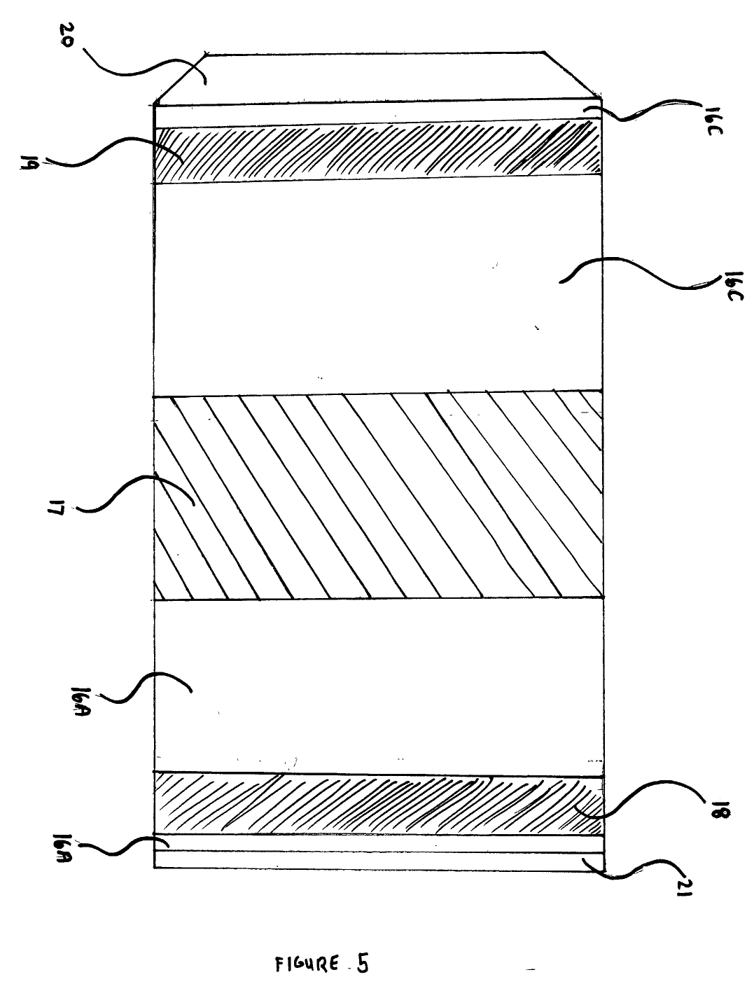

Straps 16a and 16c enable cushion grip 11 to wrap around any load handle and remain attached thereto until removed when needed. Before carrying the load, the user of cushion grip 11 wraps the strap elements 16a and 16c around the handle of a load. In this process cushion grip 11 is placed along the longitudinal axis of traction strip 17 (refer to FIG. 5) along the length of the handle of the load. A connecting strip 18 is placed along strap 16a, while a connecting strip 19 is placed along strap element 16c. Strap 16c is placed superior to strap element 16a wherein connecting strip 19 connects to connecting strip 18. Connecting strips 18 and 19 fasten to each other by means of hook-and-loop (Velcro®), zipper, buttons, string, or any other suitable means of connection, allowing for reliable and durable placement. A hem 20 along the edge of strap 16c, provides neat placement and esthetical finish. Hem 20 is made of plastic, rubber, or any other material, and is attached to strap 16c by means of stitching, staples, hook and loop or any other suitable attachment technique known in the art.

Cushion grip 11 in the invention can be used for carrying luggage or heavily loaded bags with uncomfortable handles as well as for handles of hard to operate athletic equipment and heavy machinery. The longitudinal dimension 21 can be extended further than the basic length of 10 inches in order to fit onto and cushion longer objects, such as seatbelts, shoulder straps, steering wheels and handles of doors and tools.

The hand grip can be manufactured in various longitudinal sizes so as to fit to handles of various widths. When fitted to the correct measurements, hand grip 11 is able to provide comfort and grip ease whenever the individual carrier exerts pressure on the molding hand grip. Soft cushioning action of cushion element 12 in hand grip 11 molds to the user finger features. Major advantages of hand grip 11 are the relief of any pain or discomfort associated with heavy luggage handles and the ease of use.

What is claimed is:

1. A detachable handle cushion comprising a flexible flat structure having a cushioning element disposed on at least one surface of said structure, said structure configured to attach to an elongated object,
wherein said structure is designed to change from a flat configuration into a closed configuration, said closed configuration encompassing said elongated object.

2. The cushion of claim 1, wherein first surface of said structure contains one fastener for fastening said first surface onto second surface, thereby allowing to form said closed configuration until intentionally changed into said flat configuration.

3. The cushion of claim 1, wherein said cushioning element is made of a material selected from a group of materials including synthetic and natural materials.

4. The cushion of claim 3, wherein said cushioning element is made of a material selected from a group of materials including foam, gel, liquid, cork, blister and bubble materials.

5. The cushion of claim 1, wherein said at least one surface is configured to maintain frictional contact between said structure in said closed configuration and said elongated object encompassed within said structure, wherein said frictional contact is sufficient to prevent any movement of said structure relative to said elongated object.

6. The cushion of claim 1, wherein said cushioning element is detachable from said structure.

7. The cushion of claim 1, wherein said elongated object is at least one handle.

8. The cushion of claim 1, wherein said elongated object is a machinery handle.

9. The cushion of claim 1, wherein said elongated object is an athletic equipment handle.

10. The cushion of claim 1, wherein said elongated object is a belt.

11. The cushion of claim 1, wherein said elongated object is a string.

12. A method for use of a handle cushion, the method comprising the steps of:
(a) providing a handle cushion having:
(i) a flexible flat structure having a cushioning element disposed on at least one surface of said structure;
(ii) said structure configured to attach to an elongated object;
wherein said structure is designed to change from a flat configuration into a closed configuration, said closed configuration encompassing said elongated object;
(b) wrapping said handle cushion around said elongated object; and
(c) grasping said cushion containing said elongated object encompassed therein.

13. The method of claim 12, wherein said wrapping further comprises attaching said cushion to said elongated object until intentionally detached.

14. The method of claim 12, wherein said wrapping further comprises fastening said first surface of said cushion to said second surface, thereby encompassing said elongated object within said cushion.

15. The method of claim 12, wherein said wrapping is accomplished by
(d) pulling apart at distal edges of said cushion;
(e) fitting said cushion around an elongated object; and
(f) fastening said distal edge onto said surface until firmly attached.
